(19) United States
(12) Patent Application Publication
(10) Pub. No.: US 2006/0288949 A1
(43) Pub. Date: Dec. 28, 2006

(54) Portable Heated padding for pets

(75) Inventors: Grigore Axinte, Bellevue, WA (US); Dragos Axinte, Bellevue, WA (US); Russell Borgmann, Bellevue, WA (US); John Lu, Renton, WA (US); Amy Martin, Seattle, WA (US)

Correspondence Address: WILMER CUTLER PICKERING HALE AND DORR LLP, 1875 PENNSYLVANIA AVE., NW, WASHINGTON, DC, 20004, US

(73) Assignee: Hyperion Innovations, Inc., Bellevue, WA (US)

(21) Appl. No.: 11/402,268

(22) Filed: Apr. 12, 2006

Related U.S. Application Data
(60) Provisional application No. 60/670,327, filed on Apr. 12, 2005.
(60) Provisional application No. 60/671,551, filed on Apr. 15, 2005.
(60) Provisional application No. 60/703,632, filed on Jul. 29, 2005.
(60) Provisional application No. 60/783,835, filed on Mar. 21, 2006.
(60) Provisional application No. 60/785,370, filed on Mar. 24, 2006.

(51) Int. Cl. A01K 29/00

(52) U.S. Cl. 119/169

(57) ABSTRACT

In accordance with principles described herein, portable heated pads for pets, and methods and systems for using the same, are provided that overcome some (or all) of the problems commonly associated with existing pet pads. These portable heated pads are easily transportable, and are preferably provided with cushion material. One or more heating elements, such as silver carbon paste or flexible graphite felt, are also provided in each portable heated pad. The heat settings of the one or more heating elements are controlled, for example, by one or more power switches, open loop temperature regulators, pressure push switches, sensor switches, and/or fuse circuits. A frame may also be used in connection with the portable heated pad. Various alternative embodiments are also disclosed.

### RELATED APPLICATIONS

This application claims the benefit of priority from U.S. Provisional Application Nos. 60/670,327, filed Apr. 12, 2005, 60/671,551, filed Apr. 15, 2005, 60/703,632, filed Jul. 29, 2005, 60/783,835, filed Mar. 21, 2006, and 60/785,370, filed Mar. 24, 2006, all of which are hereby incorporated by reference.

### FIELD OF THE INVENTION

The present invention relates to padding. More particularly, this invention relates to portable heated pads for use by domesticated pets.

### BACKGROUND

Portable pads are commonly used with domesticated pets. For example, small cushion-like pads are often used to provide a comfortable (e.g., cushioned) place to rest or sleep for pets such as cats and dogs, whether on the floor, in a windowsill, or at another location. While known portable pet pads are often quite versatile, most lack heating capability. Conventional pet pads that do provide integrated heating generally suffer from a lack of portability, typically requiring access to an AC power outlet to supply heating power. Additionally, known heated pet pads generally are not environmentally robust, given that they are not designed for portable (e.g., outdoor) use.

Existing heated pet pads also are prone to unreliability, as they may experience one or more failures due to a break in the heating circuit. For example, in many pet bed products, a wire filament or similar resistive heating element is used to provide the heat function to a pad. However, a single break or loss of connection in a wire or similar element can result in a complete circuit failure, thereby eliminating the heating functionality. Moreover, repairs of such breaks or losses of connection are often not feasible due to the permanent manner of construction of the pads, or are undesirably costly.

Accordingly, it is desirable to provide improved portable heated pads for pets.

### SUMMARY

An embodiment of the present invention is a portable heated bedding apparatus for pets with a cushion material sized for accommodating a pet animal. The portable heated bedding also has a heating element to provide heat to the animal lying on the cushion material. The current supplied from a battery powers the heating element. The battery may be located inside the cushion material, and inserted or removed through an opening in the material. The portable heated bedding apparatus may also have a power source selector for choosing the source of the electrical current, which may be a battery, a direct current (DC) automobile power source, or an alternating current (AC) power source. The power source selector may also be used to turn the apparatus off. Another feature is that the apparatus may have a frame for receiving the cushion material. The cushion material may be made of orthopedic foam, pillow stuffing, or any other padding material. Further, the power source selector may have an indicator for indicating when the apparatus is turned on.

In additional embodiments, a portable heated bed is disclosed with cushion material for support, and a heating element comprised of silver carbon paste silk screened upon a flexible substrate. The heating element is located at or near the outer surface of the cushion and is used for generating heat when electrical current is applied. The heating element may be powered by a direct current DC power source that is located within the cushion material, such as a rechargeable battery or an automobile power source. The portable heated bed may also have a selector for choosing the source of the electrical current, which may be either a DC of AC power source. In a third embodiment of the invention, similar to the first embodiment, the heating element is a flexible graphite fabric.

A portable heated bedding apparatus is disclosed with a heating element for generating heat from an electrical current, and a temperature controller connected to the heating element for controlling the activation of the heating element using pulse width modulation. The heating element may be powered by a direct current power source, such as a rechargeable battery or automobile power source, or the heating elements may be powered by an AC power source. The temperature controller may disconnect current from the heating element when pressure is not detected, or when the voltage supplied from the power source is below a certain threshold.

According to various preferred embodiments of the present invention, portable pet pads are disclosed that include one or more heating elements, some or each of which may be made of a flexible carbon or graphite material, or a mix of silver and carbon paste. The flexible material may be cut into a circuitous serpentine configuration.

In accordance with various preferred embodiments, the pet pad heating function is enabled using one or more portable power sources (e.g., rechargeable and/or disposable batteries), an AC power outlet, and/or a DC automobile power source (e.g., lighter plug). When one or more batteries are being used, they may be situated, e.g., internal to the cushioned portion of the heated pad, or attached to the exterior thereof. According to various embodiments, the heat settings of the one or more heating elements are controlled by one or more power switches, temperature controlled switches, open or closed loop temperature regulators, pressure push switches, sensor switches, and/or fuse circuits. Moreover, a lighting element may also be used to indicate to a user when the heating function is being used and/or when the power source (e.g., one or more batteries) is running low on power. A cutoff circuit may also be used to deactivate the heating function when the power level of the power source is determined to be below a certain threshold level.

According to various embodiments, a portable heated pet pad is used in conjunction with a frame that retains the heated pad in place. The portable heated pad (and optional frame) may be used in a variety of settings, and may be used to compensate for cold temperatures or simply to attract a pet.

Accordingly, a portable heated bedding apparatus for pets is disclosed that comprises a cushion material sized for accommodating a pet animal, a heating element to provide heat to an animal laying upon the cushion material, and at least one battery for supplying electrical current to the heating element.

Further, a portable heated bed is disclosed that includes cushion material for providing bedding support, and a heating element comprising silver carbon paste silk screened upon a flexible substrate, where the heating element is positioned at or substantially near an outer surface of the cushion material for generating heat when electrical current is applied. Alternatively, the heating element can include or be comprised of flexible graphite fabric.

A heated bedding apparatus is disclosed that comprises a heating element for generating heat from electrical current, and a temperature controller operatively connected to the heating element to control activation of the heating element with pulse width modulation.

Further, a bedding apparatus is disclosed that includes a heating element for generating heat from electrical current, a temperature controller operatively connected to the heating element to control activation of the heating element, and a sensor operatively connected to the temperature controller, wherein the temperature controller activates the heating element upon detection by the sensor that the bedding apparatus is in use.

Additionally, a portable heated bedding for a pet is disclosed, comprising a cushion further comprising a heating element and a frame for containing the cushion, wherein the cushion is removable from the frame.

### BRIEF DESCRIPTION OF THE DRAWINGS

Additional embodiments will be more apparent upon consideration of the following detailed description, taken in conjunction with the accompanying drawings, in which like reference characters refer to like parts throughout, and in which:

FIG. 1A is an illustrative front view of a portable heated bedding apparatus according to at least one embodiment of the present invention;

FIG. 1B is an illustrative side view of a portable heated bedding apparatus according to at least one embodiment of the present invention;

FIG. 1C is an illustrative side view of a portable heated bedding apparatus according to at least one embodiment of the present invention;

FIGS. 1D-1H are perspective and cross-sectional views of the rear side of a portable heated bedding apparatus in accordance with additional embodiments of the present invention;

FIG. 2A is an illustrative front view of a portable heated pad and frame according to at least one embodiment of the present invention;

FIG. 2B is an illustrative back view of the portable heated pad and frame shown in FIG. 2A according to at least one embodiment of the present invention;

FIGS. 2C and 2D are perspective views of a portable heated pad and bed frame according to additional embodiments of the present invention;

FIG. 3A depicts an arrangement of a flexible graphite heating element according to at least one embodiment of the present invention;

FIG. 3B depicts a tracing arrangement of a heater element comprised of silver and carbon, according to at least a second embodiment of the present invention;

FIG. 3C depicts a cross-section of the heater assembly of FIG. 3B, in accordance with additional embodiments of the present invention;

FIG. 4 depicts an arrangement of a flexible graphite heating element according to at least one embodiment of the present invention;

FIG. 5 depicts an arrangement of a flexible graphite heating element according to at least one embodiment of the present invention;

FIG. 6 is a circuit schematic associated with a portable heated bedding apparatus to at least one embodiment of the present invention;

FIG. 7A is a schematic of a heating circuit incorporating an open loop temperature regulator for a portable heated bedding apparatus, according to at least one embodiment of the present invention;

FIG. 7B is a schematic of circuitry for use with a pulse width modulation integrated circuit for an open loop temperature regulator, according to at least one embodiment of the present invention;

FIGS. 8A-C illustrate three duty cycles associated with the open loop temperature regulator shown in FIG. 7A according to at least one embodiment of the present invention;

FIGS. 9-13 are schematics of heating circuits associated with a portable heated bedding apparatus according to at least one embodiment of the present invention;

FIGS. 14A-G illustrate various views of a portable heated bedding apparatus in accordance with an embodiment of the invention;

FIG. 14G illustrates a portable heated bedding apparatus including a roof and at least one pocket;

FIGS. 15A and 15B depict perspective views of a portable heated bedding apparatus in accordance with an embodiment of the invention;

FIGS. 16A and 16B illustrate various views of a portable heated bedding apparatus in accordance with an embodiment of the invention; and

FIG. 17 is a diagram of a microcontroller assembly for use with a heated pet bed in accordance with at least one embodiment of the present invention.

### DETAILED DESCRIPTION OF THE PREFERRED EMBODIMENTS

The following describes portable heated pads for pets, and methods and systems for using the same. The details included herein are for the purpose of illustration only and should not be understood to limit the scope of the invention. Moreover, certain features that are well known in the art are not described in detail in order to avoid complication of the subject matter described herein.

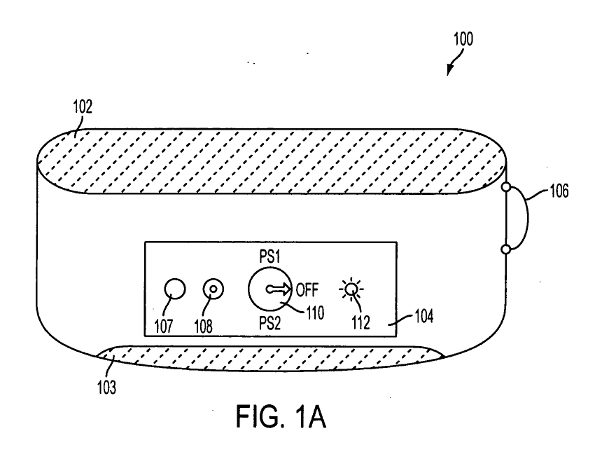

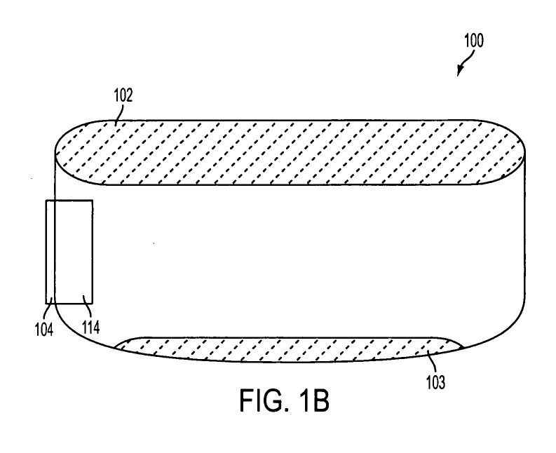

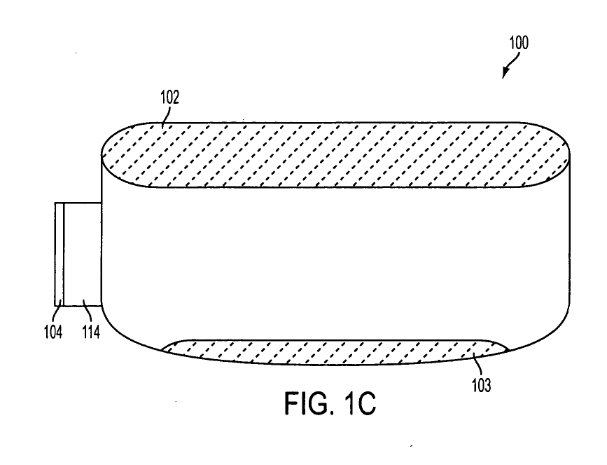

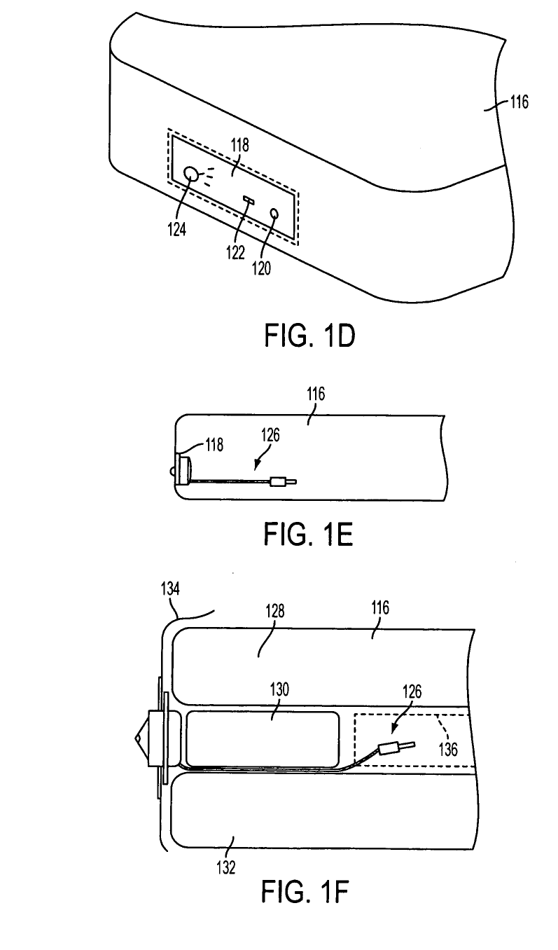

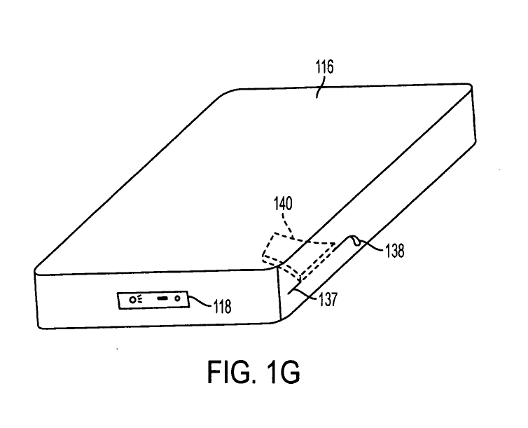

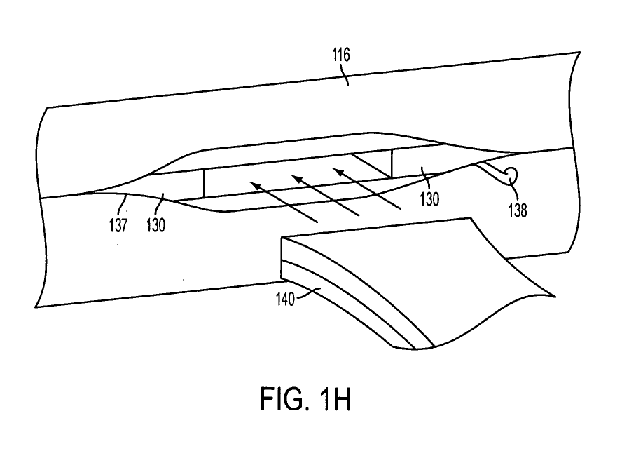

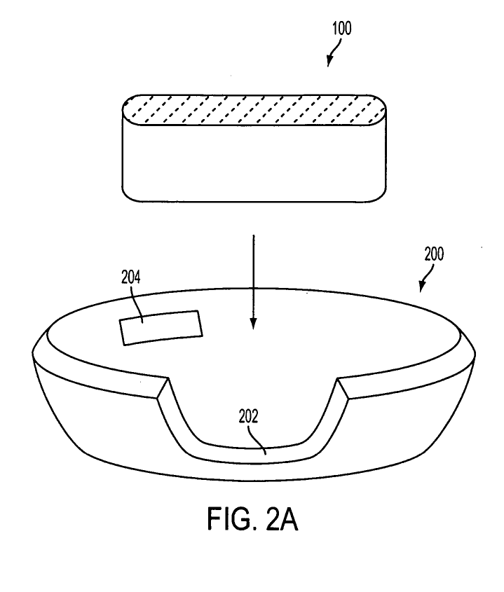

A portable heated pad is provided that includes at least one heating element for bringing the surface temperature of the pad to a temperature or maintaining a temperature that is greater than the temperature of the ambient air. FIG. 1A provides an illustrative view of a portable heated pad 100 according to various embodiments. Pad 100 shown in FIG. 1A includes surfaces 102 and 103, on which a pet may be alternatively situated when using pad 100, at least one heating element (described below in further detail), and a control panel 104. Pad 100 may also include a pad cover (not shown), and a grip or handle 106. Control panel 104 may be located on the front, rear, or a side of the pad.

Surface 102 may be made from and/or include any suitable type of material, such as a fleece, imitation sheepskin or suede material, and may be used, for example, when the ambient air temperature is relatively cool (e.g., in the winter time), during which time the pad 100 is positioned such that surface 102 is facing upward as the upper surface. Surface 103 may be made from and/or include a material such as ballistic nylon, and may be used when the ambient air temperature is relatively warm (e.g., during the summer time), during which time surface 103 is utilized as the upper surface of the bedding, and surface 102 is at the bottom portion of the bedding. In other words, the bedding can be flipped over to change the fabric surface that a pet is to lay upon. Thus, different materials may be used for surfaces 102 and 103 in order to enhance the comfort level of a pet using heated pad 100 (e.g., when external temperature changes make different types of surfaces desirable to the pet, or when a pet simply prefers a different type of, and the bedding can be reversible for different climate conditions. It is contemplated that, according to various embodiments, the heating function of pad 100 described below will be used when a particular one of the two surfaces is exposed (e.g., when the warmer surface made of fleece, imitation sheep skin, suede material, or similar material is on the top).

Additionally or alternatively, heated pad 100 may be constructed such that the material of surface 102 may be easily changed (in which case surface 103 may be unnecessary). For example, although not shown, top surface 102 may be fixably (non-permanently) attached to the remainder of heated pad 100 using, e.g., a zipper or buttons. In this case, a surface 102 made of one material may be easily replaced with a different surface 102 made of another material (and/or having different thickness) as desired. Moreover, instead of replacing one surface 102 with another, according to various embodiments, surface 102 may be constructed such that its configuration within pad 100 may be changed. For example, top portion 102 may be reversible such that its top surface is made of one material (e.g., nylon) and its bottom surface is made of another material (e.g., suede). For example, top surface 102 may be reversible inside-out, such that the material on its exterior changes when its inner surface becomes its outer surface and its outer surface becomes its inner surface. In these cases, top surface 102 may be removed from the remainder of pad 100, then turned upside-down or inside-out, for example, and re-attached to the remainder of pad 100. Such a heated pad 100 having a top surface 102 that may be re-configured as explained above to expose a different material to a pet may be extremely beneficial, for example, because it may eliminate the need for a pet owner to buy and/or store multiple top surfaces 102 (e.g., for use during different months of the year or for use by different pets).

A grip or handle 106 shown in FIG. 1 can be included to enable a user to transport heated pad 100 between different locations. The handle can be of any shape and material. For example, handle 106 may resemble a rigid briefcase handle, a piece of string attached at two locations as shown in FIG. 1, or any other suitable type of handle. As another alternative, other elements of the heated pad (e.g., control panel 104) may be used (with or without modification) as a grip or handle for transporting heated pad 100 between different locations. Although not shown, according to various embodiments, it is contemplated that a portion of heated pad 100 be extractable, where the extracted portion acts as a handle for a user for gripping pad 100.

Although not shown in FIG. 1A, heated pad 100 may also include cushion material (e.g., made from polyurethane foam or elastomer foam) or other suitable material for enhancing the comfort experienced by a pet. For example, cushion material and/or other suitable material may be located below, or substantially below, the one or more heating elements (described below in further detail) located in pad 100. Alternatively, the one or more heating elements may be positioned within, but near the upper surface of, the cushion material. It is noted that placement of cushion material or other suitable material below the one or more heating elements may, in addition to making pad 100 more comfortable, serve to reduce the transfer of heat from pad 100 to the object on which pad 100 is situated during its operation (typically, the floor). In various embodiments, the cushion material may be made of orthopedic foam, of a consistency designed to protect joints and provide appropriate support to the skeletal system of a domesticated animal and facilitate a comfortable experience for a pet resting on the heated pad. Moreover, when heated pad 100 includes cushion material, according to various embodiments, the cushion material may be removable. In other embodiments, instead of foam, the pad 100 may include a soft, pliable and re-maneuverable stuffing material to provide cushioning. Such cushioning material may include synthetic pillow stuffing such as polyester filling, or may include feathers such as goose or duck down. As a further alternatively, the pad 100 may include a combination of dense foam and softer pillow stuffing. It is contemplated that different types of cushioning may be utilized for different types of animals.

It is contemplated that the heated pet pad draws low current. As described below in further detail, a heater element can be selected that requires low power, voltage, and current, but still provides adequate heat to maintain a temperature of approximately 101° F. when combined with an animal's natural body heat. Continuing with FIG. 1A, heated pad 100 may use any suitable type of power source (or a combination of more than one type of power source). For example, power may be provided to the one or more heating elements of heated pad 100 by a portable power device, such as a battery pack that includes Alkaline batteries (such as “D” sized batteries), one or more Lithium-Ion batteries, one or more nickel-metal-hydride batteries, and/or one or more other types of batteries. As an example, heated pet pad 100 can provide heat at 101° F. for up to 8 hours with a 2000 mah battery pack.

According to various embodiments, the battery pack being used for providing power to the one or more heating elements may be rechargeable. For example, when the battery pack is partially or completely discharged (drained of power), the battery pack may be recharged by removing it from pad 100 and placing it in a stand alone charging device that charges the battery pack using power from, e.g., an AC power outlet. In this case, a different, pre-charged battery pack may be connected to (and used to provide power to) circuitry of pad 100 while the original battery pack is charging, thereby substantially reducing the amount of time that pad 100 will go without power when the original battery pack is discharged. It is noted that, when a removable battery pack is used in connection with pad 100, this battery pack will be electrically connected to control panel 104. As described below in further detail, the battery pack can be disconnected from the control panel 104 when it is removed from pad 100 for recharging. Alternatively, the battery pack may be attached to the control panel 104 in a manner such that the control panel 104 is removed as well with the battery pack. The invention is not, however, limited in this manner.

According to various embodiments, such as the one shown in FIG. 1A, a battery pack that includes one or more rechargeable batteries may also be recharged while the battery pack is still connected to the heating circuit of pad 100. For example, this may be done by connecting a battery charger (e.g., plugged into an AC outlet) to the drained battery pack using connection port 107 of control panel 104. The charging circuitry for charging the battery pack also may be included in the heating circuit of pad 100.

When an external power source is used to provide power to heated pad 100, for example, this power source may be connected to heated pad 100 using connection port 108 of control panel 104. For example, when heated pad 100 is being used in an automobile, it may be powered by the automobile (e.g., by a lighter plug) using connection port 108. As another example, when an AC power outlet (e.g., in a home) is being used to power heated pad 100, power from the power outlet can be converted using an AC/DC converter (not shown) and provided to heated pad 100 also using connection port 108 (or another, similar connection port). When an AC/DC converter is being used, it may be included with (part of) the circuitry of heated pad 100, or may be included with the AC power plug. The invention is not limited in this manner that connects the AC outlet to connection port 108. When the heated pad is being powered by an AC power outlet, it can be appreciated that by configuring the heater to draw low current, a low voltage will be provided across the power cord, which will minimize harm should a pet chew through the power cord.

It is noted that, according to various embodiments, a single connection port (not shown) may be used in place of connection ports 107 and 108 shown in FIG. 1A. In this case, for example, an external (e.g., AC outlet) power source may be used to simultaneously power one or more heating elements of pad 100 and to charge one or more portable power sources of pad 100.

As shown in FIG. 1A, in addition to connection ports 107 and 108, control panel 104 may include a power switch 110 and a lighting element 112. Power switch 110 may be a knob (dial) or other type of switch for allowing a user to select the power source of heated pad 100 and to turn the heating function of pad 100 OFF. For example, when power switch 110 is in a center position, as shown in FIG. 1A, the heating function of pad 100 will be OFF. When a user selects a first power source (“PS1”) by turning or otherwise adjusting power switch 100, a first source of power may be used, such as a rechargeable battery pack connected to the heating circuit of pad 100. When a user selects a second power source (“PS2”) by turning or otherwise adjusting power switch 100, a second source of power may be used, such as an AC outlet or automobile lighter plug. It will be understood that, although a particular type of power switch 110 is shown in FIG. 1A, the invention is not limited in this manner. For example, rather than taking the form of a knob, according to various embodiments, power switch 110 may include three separate buttons for selecting between the OFF position, PS1, and PS2. Other variations are also contemplated.

When power is being supplied to heated pad 100, an optional lighting element 112 of control panel 104 may be activated. For example, lighting element 112 may cause a green colored light to turn ON when power is being supplied to pad 100. Moreover, according to various preferred embodiments, lighting element 112 may also serve to notify users when a power source being used is coming close to being discharged (e.g., when its power level falls below a predetermined threshold level). In this case, for example, a red light may be used to indicate that power is being supplied to pad 100, but that the power source will need to be recharged or replaced in the near future. According to various other embodiments, a second lighting element (not shown) that is similar to lighting element 112 may be used for the purpose of indicating that a power source being used is coming close to being discharged (as discussed below in further detail). Moreover, according to various embodiments, rather than (or in addition to) providing a light indicator when the power source will need to be replaced in the near future, and an audible indication may also be provided.

FIGS. 1B and 1C provide illustrative side views of the pad 100 in FIG. 1A, corresponding to two alternative embodiments. As shown in FIG. 1B, control panel 104 described above in connection with FIG. 1A may be located substantially on a side surface of heated pad 100. Moreover, as shown in FIG. 1B, a portable power source 114 (e.g., a disposable or rechargeable battery pack) may be situated inside the cushioning (when present) of heated pad 100. Alternatively, as shown in FIG. 1C, both control panel 104 and portable power source 114 may be situated external to a side surface of heated pad 100. It will be understood that the invention is not limited by the particular placement of either control panel 104 or portable power source 114 with respect to the remainder of pad 100. Moreover, in both of the embodiments shown in FIGS. 1B and 1C, control panel 104 may be either permanently or fixably attached to power source 114. In the latter case, for example, control panel 104 may be removed from heated pad 100 without forcing the removal of power source 114.

It is noted that, when a pad cover such as described above is being used, it may serve to protect control panel 104 and/or power source 114, even when one or both are situated in an external manner such as shown in FIG. 1C. When a pad cover is used, according to various embodiments, it may be made from vinyl or another suitable material that is able to withstand low and high temperatures, rain, moisture, and the like. Such a pad cover may also include one or more logos (e.g., advertisements) on its surface. It is also contemplated that the exterior of control panel 104 and/or power source 114 may be rigid and environmentally robust, such that either or both of these elements remain adequately protected even when the optional cover is not designed to cover these elements. Additionally, according to various embodiments, any cover that is being used may be removable (e.g., using a zipper or buttons), and may be machine or hand washable. Moreover, the bottom of such a cover (or pad 100 itself) may be provided with one more gripping elements (not shown) that may be used to prevent sliding when heated pad 100 in being used, e.g., on a slippery surface.

In one embodiment, the top portion 102 in FIGS. 1A-1C is made of suede, such as passion suede, which is a water-resistant, durable and soft fabric. The bottom of the pad 103 is preferably made of a nylon material to act as a “cool” side where heat is not applied. In this manner, the pad can be flipped over such that a pet rests against the nylon material on the cushion. When the pad is used in conjunction with a “bed” or frame, as described in further detail below, the bed preferably is also made from passion suede, and the bottom of the bedding is made of a non-slip material.

FIGS. 1D-1F illustrate the rear portion of a pad 116 in accordance with an embodiment of the invention. As can be seen in FIG. 1D, pad 116 includes a control panel 118, which is located nearly flush with the rear wall of the pad. The control panel includes a power connection input 120, an LED indicator 122, and a 3-position dial 124. Alternatively, the dial can be replaced with a 3-position slide switch. FIG. 1E provides a cross-section view of the rear portion of the pad 116. The back portion of the control panel 118 is mounted within the pad 116 itself. A cord 126 is attached to the control panel 118 to electrically connect the panel to a battery pack (not shown) that is to be inserted into the pad 116. FIG. 1F provides a more detailed cross-sectional illustration of the pad assembly 116. In the pad, beneath the fabric 134, a first foam 128 is provided for the upper portion of the pad. A second foam 130 may be provided beneath a portion of the first foam 128. This second foam 130 surrounds the battery, which is placed in a section 136 defined by the bottom the first foam, the front of the second foam, and the top of a third foam 132.

FIGS. 1G and 1H illustrate the physical relationship between the battery pack 140 and the control panel 118 and the control panel 118. FIG. 1G is a perspective view of the pad 116 that illustrates the location of the control panel 118 at one end of the pad 116, and zip-type enclosure 137 at an adjacent end to allow insertion of the battery pack 140. Alternatively, zipper 138 can be substituted with a Velcro material or any other material to allow the seam to be opened and closed. FIG. 1H provides a more detailed illustration of the seam 137 at the side of the pad 116 where the battery pack is to be inserted. As can be seen, when zipper 138 opens the seam, the battery pack 140 can slide into a cavity defined by second foam 130 at the sides, with the first foam 128 above and third foam 132 below.

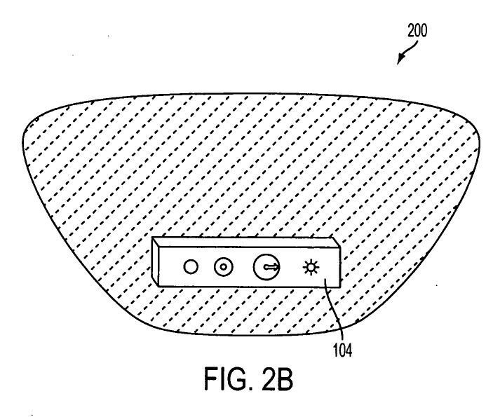

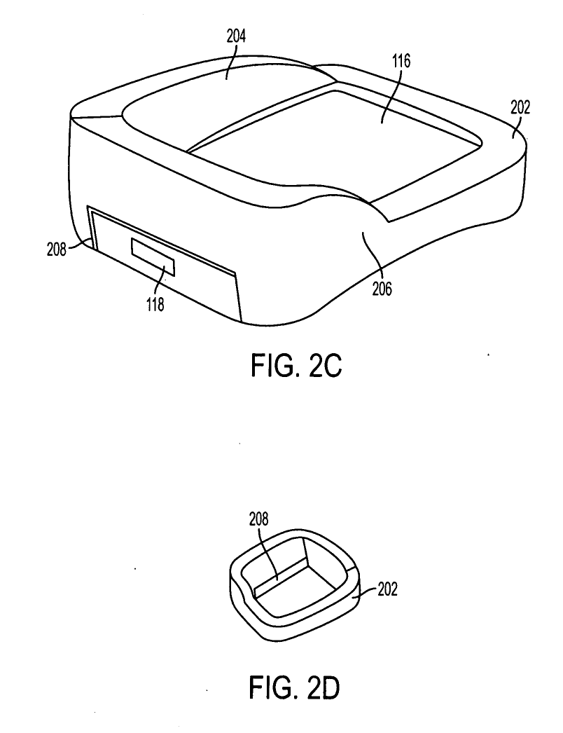

As shown in FIG. 2A, heated pad 100 described above and shown in FIGS. 1A-C may be used in conjunction with a frame 200 that retains heated pad 100 in place. For example, as shown, frame 200 may include an optional lowered wall portion 202 that facilitates a pet's entry and exit from frame 200. Additionally, as shown, frame 200 may include an optional cutout section 204. As shown in FIG. 2B, which provides a back view of frame 200, when cutout section 204 is present, heated pad 100 may be placed in frame 200 such that control panel 104 described above may extend from (or be accessible through) frame 200.

FIG. 2C is a perspective view of a heated pad 116 (referring to FIGS. 1D-1H) in conjunction with a bed frame 202 in accordance with a preferred embodiment of the invention. In this figure, bed frame 202 includes a tapered long wall 204 and short wall 206 for housing a pet while resting on heated pad 116. Preferably, bed frame 202 is comprised of a single, integrated structure. As described above, the upper surface of bed frame 202 is made of passion suede, while the lower portion (not shown) is covered with a non-slip material. The lower rear portion of the bed frame includes a notch 208 by which heated pad 116 can be inserted or removed. This notch also enables an operator of the heated pad 116 to access the control panel 118. FIG. 2D is another perspective illustration of bed frame 202, with the notch 208.

For when the heated pad 116 and the bed frame 200 are to be washed, a mesh-type or nylon bag optionally may be provided to contain the two components of the product together.

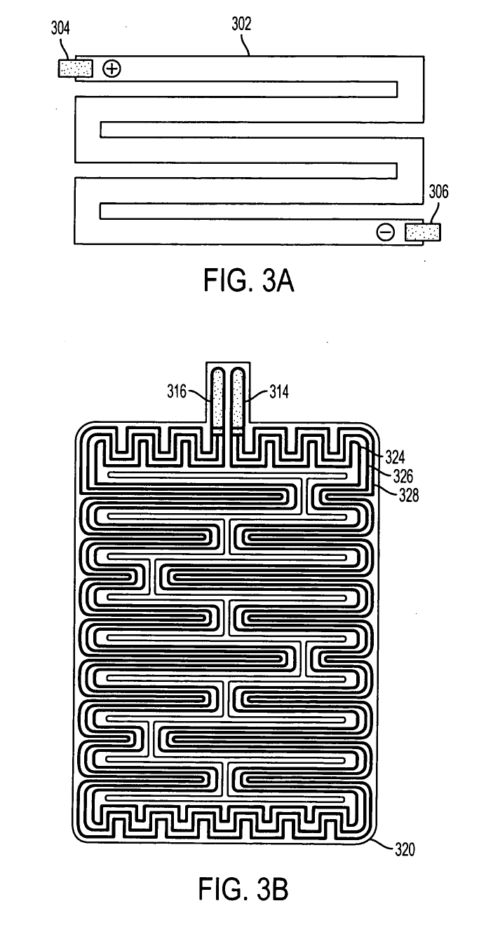

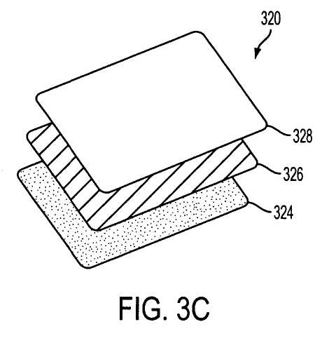

The heating elements that may be used in accordance with the preferred embodiments are now explained in greater detail with reference to FIGS. 3-5. FIG. 3A shows one configuration of a heating element 302 for use in a portable heated pet pad such as shown in FIGS. 1A-1C and described above. According to various embodiments, heating element 302 is made of a mix of carbon and silver paste. Alternatively, heating element 302 may be made of a flexible carbon material, or a flexible graphite material, such as flexible graphite foil. According to other embodiments, heating element 302 may be made, for example, of a flexible graphite fabric, or a flexible graphic felt, such as TDG soft graphite felt manufactured by SGL Carbon Group of Valencia, Calif. Moreover, according to various embodiments, the thickness of the flexible graphite being used may be approximately ⅛ inch. According to other embodiments, this thickness may be less (e.g., 1/16 inch) or more (e.g., ¼ inch). It will be understood that the invention is not limited by the particular thickness, grade, or weave of the flexible graphite heating element 302 that is used.

As shown in FIG. 3A, heating element 302 may be cut into a circuitous serpentine configuration. It is noted that, according to various embodiments, the spacing of heating element 302 shown in FIG. 3A (and the spacing present in other heating elements described herein) may remain free of materials, or may include, for example, insulation material. As shown in FIG. 3A, heating element 302 may include electrical contacts 304 and 306 on either end. According to various embodiments, electrical contacts 304 and 306 are formed by attaching metal plates (or similar components) to the top and bottom surfaces of either end of heating element 302. In alternate embodiments, only one of the top and bottom surfaces of either end of heating element 302 will be in contact with electrical contacts 304 and 306, respectively. Electrical contacts 304 and 306 may be made, for example, of copper or brass. Moreover, electrical contacts 304 and 306 may, for example, be pressed onto either end of heating element 302, and may be screwed or riveted thereon. Moreover, although not shown, more than one electrical contact may be used on either or both ends of heating element 302. The invention is not limited in this manner.

FIG. 3B illustrates a circuitous serpentine configuration for three parallel traces (324, 326, 328) of a mix of carbon and silver paste, which together form heater 320. Heating element 320 may include electrical contacts 314 and 316 on either end. By arranging the traces in parallel, the heater will still provide a circuitous connection to provide heating capability if one or even two of the trace lines should have a break in continuity. Further, having three traces in parallel maximizes the heat distribution to be applied to the seat. This arrangement avoids “hot spots” and “cool spots” on the seat to provide a more comfortable environment for a pet lying thereon. The heating element 320 may include electrical contacts 314 and 316 on either end. As will be described below in further detail, contacts 314 and 316 may connect to output pins of a microcontroller, which controls the application of electrical power to the heater assembly.

As shown in FIG. 3C, the heater is comprised of three components. The heater 320 is first comprised of a backside acrylic adhesive laminate 324, where one side is an adhesive, and the other side is polyester film. The substrate can be polyethylene terephthalate (PET), a polyester thermoplastic polymer, or it may be silicone. On the polyester film, a silver carbon paste is screen-printed (shown as second layer 326). It is then sent through ovens and cured, and then a top layer of polyester film 328 is applied. The final product is very flexible and durable.

After the paste is printed on a substrate, the heater is die cut into shape. The gaps between bars (as shown in FIG. 3D) allow freedoms of deflection so that the heater is more durable. As it is die cut, two holes for the connector are punched at the beginning and end of the traces. This allows rivets and washers to be mounted, before the backside adhesive is applied, to complete the process. Wires are later soldered to the connectors. The backside adhesive may include adhesive on at least a portion of the opposite side (e.g., a pressure sensitive adhesive along the bottom periphery), so as to adhere to the top of the cushion material described above.

In operation, when a pet is lying on the heated pad, the heating element 320 as shown and described can maintain a temperature over 100° F. (e.g., 102° F.) for at least 7 hours when powered by a 12AA NiMH Rechargeable battery pack (2000 mah), providing 14.4V nominal (fluctuating between 16.8V and 12V). If a pet is not lying on the pad, the heater can maintain a temp of 12-17° F. above ambient for at least 7 hours when powered. The total length, width and configuration of the traces affect the resistance of the heater, which can be selected to be approximately 52 ohms. An iterative process is utilized to adjust these parameters until a desired heating temperature and power level are attained. In at least one embodiment, the resistance and power source requirements are selected to provide sufficient heat for at least the duration of an airline flight, and the heater size is determined to fit within an animal cage that is to be used in a cargo-hold of an airplane. In at least another embodiment, the resistance and power source requirements are selected to size a heater for use with padding to be attached to a windowsill.

The use of a mix of silver and carbon paste or of a flexible graphite material (e.g., felt) as described herein in accordance with various embodiments provides several benefits. For example, because of the wide surface area of these materials compared to a traditional wire heater, heat distribution on the surface of the heated pad will be substantially more uniform. Moreover, the relatively large surface area enables larger electrical contacts (e.g., using contacts 304 and 306), thereby reducing the likelihood of an unwanted break in the circuit. With regard to a paste, it is easy to run several traces in parallel in case one should experience a break in connection. As for graphite materials, such as a graphite fabric, a break at one point in the graphite material (e.g., in the center) is much less likely to result in a deactivation of the heating circuit, given that a complete break in the connection is significantly less likely to take place. For this reason, a heated pad made of either material is much more durable than traditional heated pads. Other benefits will also be apparent to persons versed in the art.

Another significant benefit to incorporating a silver carbon paste heater or graphite felt heater in a pet bed product is that it enables the product to heat much more quickly than in products with conventional nichrome wire heaters. Referring to FIG. 1F, because the silver carbon paste heater or graphite felt heater is very flat, flexible and durable, it can be placed on top of the first cushion 128, just under the fabric 134. Even though the heater is in close proximity to the pet, it does not affect the smoothness of the surface of the heated pad because the heater material is substantially flat. In comparison, since a nichrome wire heater is not substantially flat, it may be placed within foam so as not to be noticeably uncomfortable. In this scenario, the nichrome wire heater will not heat the surface as efficiently or quickly. Furthermore, because the graphite felt heater or silver carbon tracing heater are both very flexible, the heater element can remain in close proximity to the animal by adapting to the contours that the animal creates in the cushioning by lying in the bed.

An exemplary calculation associated with the dimensions of heating element 302 is now described. In an embodiment using flexible graphite, the initial heat up power (Pᵢ) may be 20 W, the resistivity (ρ) of the graphite felt being used along the transverse direction may be 0.0655Ω-inch, the initial battery pack voltage (Vᵢ) when the heated seat circuit is loaded may be 12 V, and that the thickness (T) of the heating element may be ⅛, or 0.125, inches. Of course, all of these dimensions may be varied. For example, the voltage may be 14, 15, or beyond 16 V, depending whether the source is a battery, a car adapter, or an AC adapter. Assuming these dimensions, however, the current (I) is equal to Pᵢ/Vᵢ=20/12=1.67A, and the total resistance of heating element 302 (R) is equal to Vᵢ/I=7.19Ω. Using the equation R=(ρ*L)/(W*T), the length (L) to width (W) ratio of resistive element 302 may be computed as follows: LIW=(R*T)/ρ=(7.19Ω*0.125 in)/(0.0655Ω-in )=13.7. According to various embodiments, if the width (W) of heating element 302 is 2.5 inches, heating element 302 is configured such that its length (L) is equal to 34.25 inches.

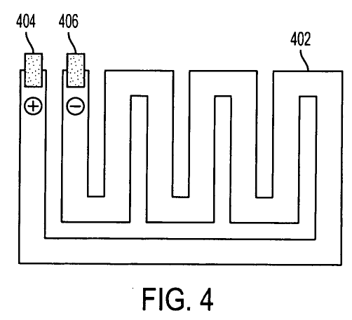

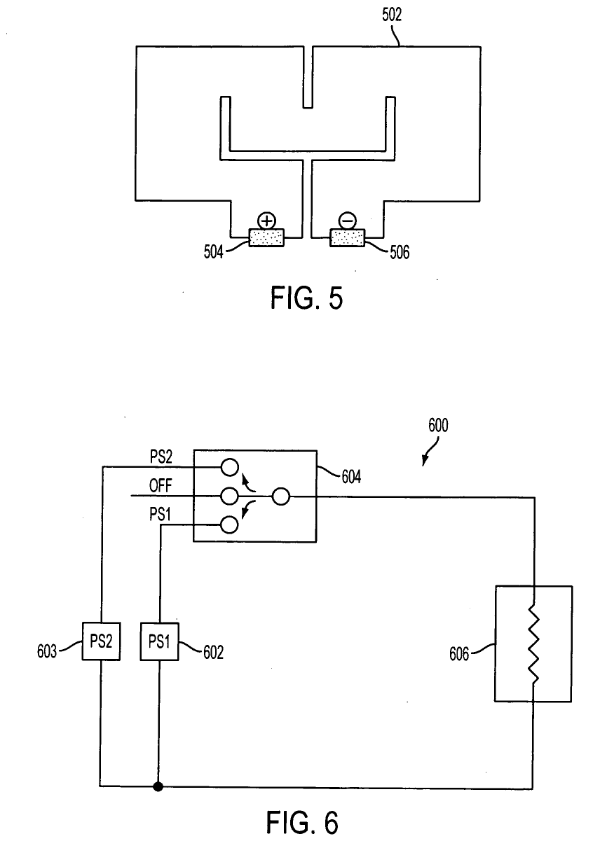

FIG. 4 shows another circuitous serpentine configuration of a flexible graphite heating element 402 with electrical contacts 404 and 406 in accordance with various embodiments. It is noted that, according to various embodiments, the use of a configuration (such as that shown in FIG. 4) in which the ends of the heating element are in close proximity to each other may be desired, e.g., to facilitate connection to the power source being used (e.g., to the positive and negative terminals of the battery pack being used). FIG. 5 shows yet another configuration of a circuitous serpentine flexible graphite heating element 502 with electrical contacts 504 and 506 in accordance with various embodiments that is similar to the one shown using dotted lines in FIG. 1, and which also includes ends that are in close proximity to each other. Other configurations are also contemplated. For example, while heating elements 302, 402, and 502 shown in FIGS. 3-5 are substantially rectangular in shape, the invention is not limited in this manner. Thus, for example, heating elements may be used in accordance with various preferred embodiments that have rounded edges, that are oval shaped, star shaped, or of any other suitable shape.

The particular dimensions and configuration of the heating element being used (e.g., heating element 302, 402, or 502) may be chosen (based, e.g., on calculations such as those described above) in any suitable manner such that specific desired heater resistance requirements are met.

FIG. 6 shows a schematic of a circuit 600 associated with a portable heated pad according to various embodiments. The circuit shown in FIG. 6 includes power sources 602 and 603 (although one of these may be absent according to various embodiments), power switch 604, and heating element 606. According to various preferred embodiments, power sources 602 and 603 may each be any suitable type of power source. For example, power source 602 may correspond to portable power source 114 (e.g., a battery pack) as described above, and power source 603 may correspond to power received from an AC power outlet or an automobile power source (e.g., lighter plug) as described above. The invention is not limited by the types of power sources being used, or by the number of power sources being used. For example, when three power sources are being chosen from, power switch 604 would establish a connection between one of the three power sources, or when the heating function is to be OFF, neither of these power sources.

Power switch 604 shown in FIG. 6 may correspond, for example, to power switch 110 of control panel 104 described above. As shown, power switch 604 may be used to select from power sources 602 and 603, or to turn circuit 600 OFF (by selecting neither power source). Thus, when multiple power sources are being used, power switch 604 is not only used to turn the heated pad ON and OFF, but also to select one of a plurality of power sources.

Heating element 606 shown in FIG. 6 may be any suitable type of heating element, such as a flexible silver carbon mix paste or graphite heating element, as described above.

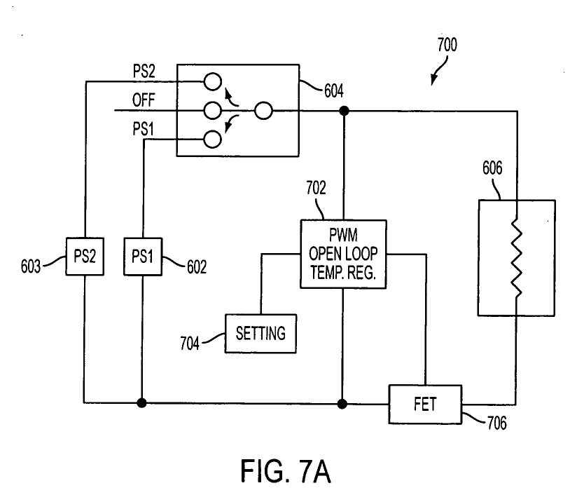

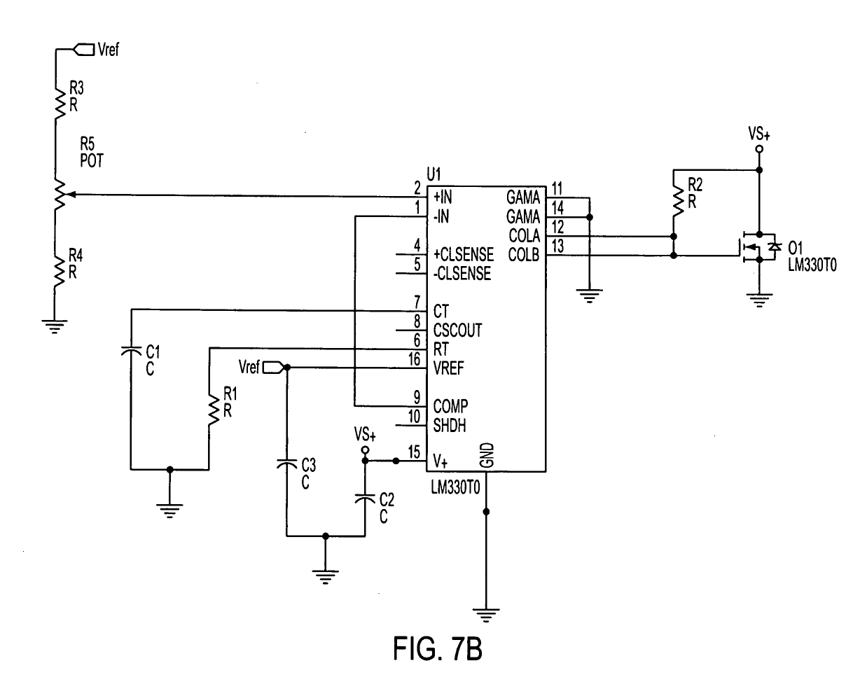

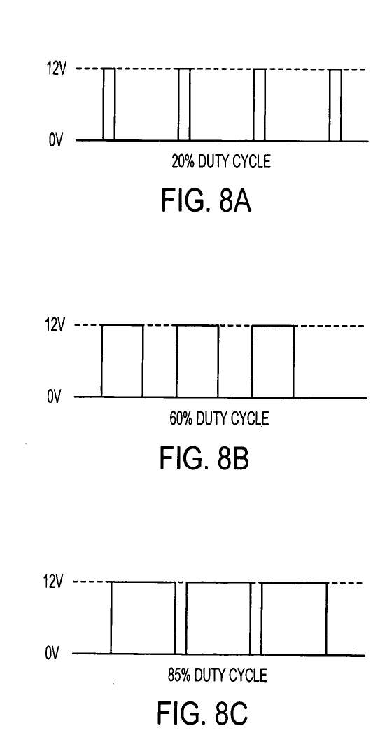

FIG. 7A shows another circuit 700 associated with a portable heated pet pad. Circuit 700 is similar to circuit 600 shown in FIG. 6, but also includes an open loop temperature regulator, such as pulse-width-modulator (PWM) circuit 702, for regulating the temperature of a heated pad. A user may manipulate a control setting 704 (e.g., a switch, knob, or the like) that controls field effect transistor (FET) 706 or another suitable type of circuit device, which in turn controls the amount of time that heating element 606 is activated. For example, FIGS. 8A-8C illustrate three possible duty cycles associated with PWM 702, which correspond, for example, to three different settings of control setting 704. Other duty cycles may also be implemented. Moreover, it is contemplated that, in various embodiments, control settings can be configured for a certain number of discrete settings, while in other embodiments, a substantially unlimited number of settings will be possible (e.g., using a knob rather than a switch mechanism). As will be described below in further detail, the duty cycle generated by PWM circuit 702 may be adjusted automatically based upon a pet's movement so as to improve the pet's comfort, or to more quickly or efficiently provide heat for the pet.

FIG. 7B is a schematic diagram showing PWM circuit 702 according to at least one embodiment. It will be understood that, although not shown, a closed loop temperature regulator may also be used according to various embodiments. Alternatively, the circuitry can include an integrated circuit controller (microcontroller), as will be described below in further detail. In FIG. 7B, PWM circuit 702 is National Semiconductor chip LM 3524, a dedicated PWM circuit. As inputs, the circuit includes a potentiometer 710, which is a variable resistor that changes the voltage at pin 2 to change the duty cycle of the PWM. Resistors 712 and 714 provide a voltage divider from VREF for the potentiometer. Together, resistor 716 and capacitor 718 set the oscillation frequency. Capacitors 720 and 722 are used to stabilize the line. Finally, the output to FET 724 is for turning on and off the heater in accordance with the PWM settings.

In at least one embodiment, a user may manipulate a control setting 704 (e.g., a switch, knob, or the like) that controls field effect transistor (FET) 706 or another suitable type of circuit device, which in turn controls the amount of time that heating element 606 is activated. For example, FIGS. 8A-8C illustrate three possible duty cycles associated with PWM 702, which correspond, for example, to three different settings of control setting 704. Other duty cycles may also be implemented. Moreover, it is contemplated that, in various embodiments, control settings can be configured for a certain number of discrete settings, while in other embodiments, a substantially unlimited number of settings will be possible (e.g., using a knob rather than a switch mechanism).

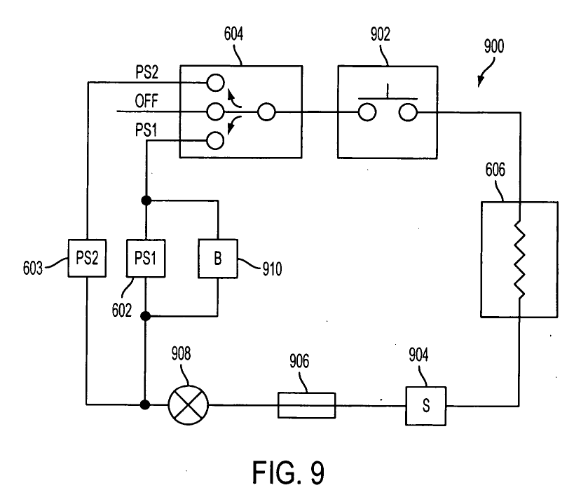

FIG. 9 shows yet another circuit 900 associated with a portable heated pad according to various embodiments. Circuit 900 is similar to circuit 600 shown in FIG. 6, but also includes a pressure activated push switch 902 that may be activated by a pet that is using the portable heating pad. For example, assuming a user has switched power switch 604 to one of the two ON positions, the circuit shown in FIG. 9 automatically activates when the pet for which the heated pad is designed sits or otherwise exerts pressure on pressure switch 902, and is automatically deactivated when the pet leaves the heated pad or otherwise removes the exerted pressure from pressure switch 902. In this manner, the power source being used (e.g., power source 602 or 603) may be preserved by turning off the heating function when the pad is not being used by a pet. It is noted that the amount of pressure required to activate pressure switch 902 (and other similar switches described below) may be adjustable. In this case, a user would adjust the pressure setting according to the weight of the pet that is to use the heated pad.

As shown, circuit 900 also includes a sensor switch 904 that is designed to sense whether the heated pad is in a position that is suitable for a pet to sit thereon, and to deactivate circuit 900 when this is not the case. For example, assuming that power switch 604 is in one of the ON positions, and that pressure switch 902 is either not present or pressure is somehow being exerted thereon, according to various embodiments, circuit 900 may nonetheless be deactivated when sensor 904 determines that the heated pad is being transported (and thus, is not currently being used). For example, sensor 904 may be configured to detect motion and/or angular (e.g., non-horizontal) positioning. It is noted that sensor 904 may operate using any suitable means of detection, including, for example, a level detector or a gyroscope.

Also included in circuit 900 shown in FIG. 9 is a fuse circuit 906. Fuse circuit may be any suitable type of fuse circuit that is capable of providing overcurrent protection. For example, fuse circuit 906 may be designed to melt and open circuit 900 under abnormally high electric loads. Alternatively, according to various preferred embodiments, fuse circuit 906 will operate to only temporarily open circuit 906. In this manner, the triggering of fuse circuit 906 may not require servicing of the heated pad. As also shown in FIG. 9, circuit 900 may include an on/off indicator 908 for providing an indication relating to the operating status of the heated pad. For example, indicator 908 may correspond to lighting element 112 described above, and may not only provide an on/off indication, but may also provide a lower power lever indication (using additional circuitry not shown that detects the power level of, e.g., power source 602). According to various embodiments, one or more light emitting diodes (LED) may be used for providing the light indication, although the invention is not limited in this manner. Circuit 900 shown in FIG. 9 also includes a cutoff circuit 910 that is designed to deactivate power source 602 when its power level is determined to be low (e.g., below a predetermined threshold voltage level). Although one particular configuration of cutoff circuit 910 is shown in FIG. 9, it will be understood that other configurations are also contemplated.

Alternatively, a resettable thermostat may be used for safety, in case there is a malfunction and the heater overheats.

It is noted that, although circuit 900 includes both power switch 604 and pressure activated switch 902, the invention is not limited in this manner. That is, according to at least some of the preferred embodiments, power switch 604 will not be present when pressure activated switch 902 is being used, such as when only a single power source is being used. Additionally, even when multiple power switches are being used, power switch 604 may be eliminated by using circuitry (not shown) that automatically detects the presence of power source 603 (e.g., power from an AC outlet), in which case power source 603 is automatically selected. Such automatic detection may also be used without the use of pressure activated switch 902. Moreover, although not shown, according to various preferred embodiments, a bypass switch or similar mechanism maybe used to bypass (disable), e.g., any or all of pressure switch 902, sensor switch 904, fuse circuit 906, on/off indicator 908, and cutoff circuit 910.

Another type of sensor switch that may be utilized according to an embodiment of the present invention is a vibration switch. When the heated pet pad is in use by a pet, the surface of the pad will experience slight vibrations and movement, which will trigger a sensor to send signals to an integrated circuit microcontroller. The signal will then reset a timer circuit. If the timer circuit has not been reset within, for example, 8 minutes, the microcontroller will switch off power to the heater, and accordingly, the application of heat to the apparatus. In this manner, the vibration sensor acts in conjunction with the microcontroller to provide power save functionality to automatically turn off the heater and conserve battery power when the apparatus is not in use.

In FIG. 9, the sensor 902 can be replaced with a vibration switch. The vibration sensor acts as a tilt sensor/rolling ball switch, but can be used to detect vibration instead of tilt. A ball is encapsulated in a cylinder. When the cylinder is tilted it acts as a switch, such that the ball either electrically closes or opens the circuit depending on where the ball is. In normal operation for a heated seat in the at least one embodiment, the ball is on the sensor. Any slight vibration causes the ball inside to momentarily jump off the sensor, creating a signal to the microcontroller. A suitable vibration switch is provided by Yusan Electronic Co., Ltd., as the SW-200 series.

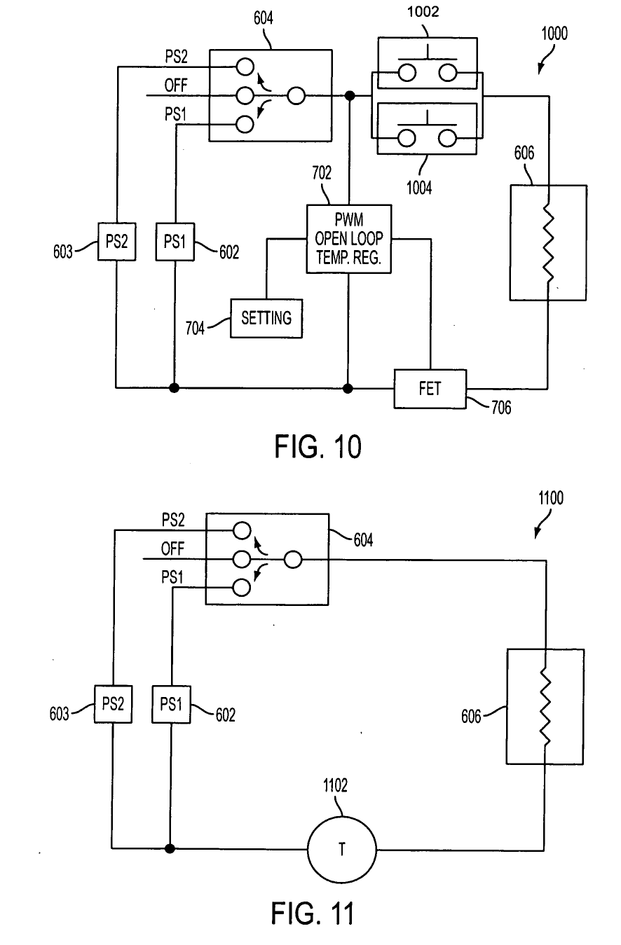

FIG. 10 shows yet another circuit 1000 associated with a portable heated pad according to various embodiments. Circuit 1000 is similar to circuit 700 shown in FIG. 7A, but also includes a pair of pressure activated push switches 1002 and 1004 that may be activated by a pet using the portable heating pad. As shown, pressure activated switches 1002 and 1004 are placed in parallel in circuit 1000, such that when pressure is exerted on either, circuit 1000 is activated. One advantage associated with using a pair of pressure activated switches 1002 and 1004 in this manner, rather than a single pressure switch (as with circuit 900 shown in FIG. 9), is that a pet will be more likely to activate at least one of switches 1002 and 1004 (especially when they are placed apart from each other) when using the heated pad. Moreover, according to various embodiments, more than two pressure switches may be used. For example, respective pressure switches (e.g., connected in parallel) may be placed in at four corners of the heated pad, and optionally also in the center, thereby further reducing the chances that circuit 1000 will not be activated when the heated pad is in use. According to various other embodiments, when more than one pressure switch is being used, one or more of these switches may be placed in series such that pressure must be exerted on each in order for circuit 1000 to be active. This may be desirable, for example, to prevent accidental activation of circuit 1000. It is also contemplated that two or more pressure switches be placed in series at the same time that two or more pressure switches are placed in parallel. Thus, the invention is not limited by the number of pressure switches used, the placement or location of these switches, or the manner in which these switches are connected (e.g., in series or in parallel).

FIG. 11 shows still another circuit 1100 associated with a portable heated pad according to various embodiments. Circuit 1100 is similar to circuit 600 shown in FIG. 7A, but also includes a temperature-controlled switch 1102 for selectively activating and deactivating circuit 1100 based on one or more temperature readings. For example, temperature controlled switch may be associated with a thermostat (not shown) that detects the temperature at one or more points on the surface of the heated pad. When the temperature (or average temperature) is below a predetermined lower limit (e.g., 90° F.), circuit 1100 may be automatically activated by temperature controlled switch 1102. On the other hand, when the temperature (or average temperature) measured by this thermostat is above a predetermined lower upper (e.g., 110° F.), circuit 1100 may be automatically deactivated by temperature controlled switch 1102. In this manner, the temperature of the heated pad can be automatically controlled based on real-time temperature readings on its surface (or other determined locations). According to various other embodiments, temperature controlled switch 1102 may be used only to prevent the heating of the pad above a predetermined amount (e.g., 110° F.). In this case, temperature controlled switch 1102 may act as a safety cutoff switch. Moreover, according to various embodiments, a second thermostat (not shown) may also be used to measure the temperature of, e.g., ambient air. In this case, temperature controlled switch 1102 may be used according to various preferred embodiments to bring the surface temperature of the pad to a temperature (or maintaining a temperature) that is a predetermined amount higher than the surrounding temperature (e.g., of the ambient air). For example, in this manner, the temperature of the heated pad can be maintained at approximately 15 degrees above the ambient air temperature in order to attract a pet (as may be desirable, e.g., when transporting a pet in an automobile, such that the pet is more likely to remain situated in one location). Moreover, according to various preferred embodiments, the temperature of the heated pad can be maintained at approximately 15 degrees above the ambient air temperature in order to attract a pet, and may be raised to a higher temperature once a pet is detected (e.g., using a pressure switch as described above) or another condition is met.

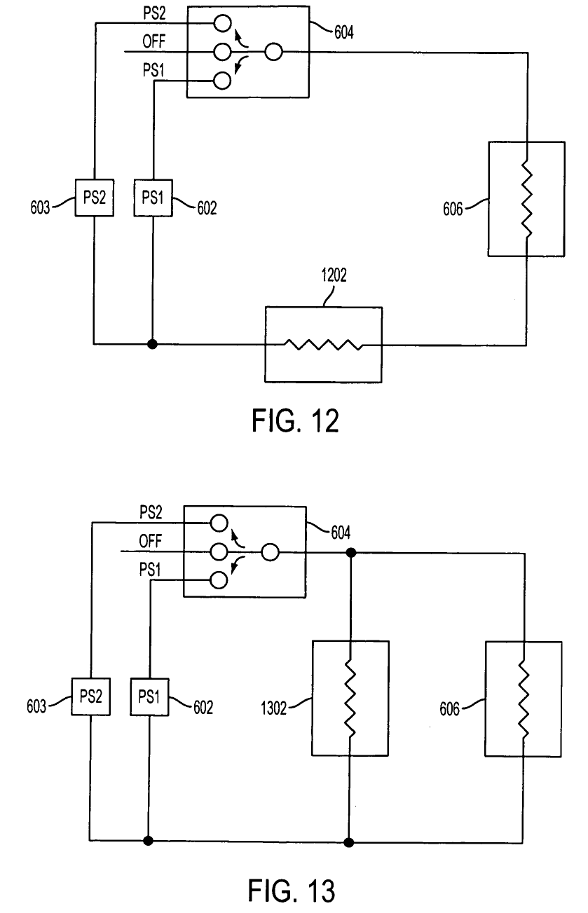

According to various embodiments, more than one heating element may be used in connection with a portable heated pad. FIG. 12 shows a circuit 1300 that may be used in connection with more than one heating element. Circuit 1300 is substantially similar to circuit 600 shown in FIG. 6, but also includes a second heating element 1202 connected in series with heating element 606. According to various other embodiments, as shown in FIG. 13, a second heating element 1302 being used in the portable heated pad may be connected in parallel with heating element 606. It is also contemplated that three or more heating elements be used in a heating pad according to various preferred embodiments (using any suitable combination of series and parallel connections). It is noted that, when more than one heating unit is being used, according to various embodiments, the temperature setting for each (or at least some) of these heating units may be separately controlled. For example, when a relatively large pad is being used for multiple pets, different portions of the pad may be set to different temperature levels (e.g., corresponding to the individual pets). Additionally, when one or more push switches are being used in connection with different heating elements, these switches can be used to conserve power by only heating certain portions of the pad corresponding to locations in which one or more pets are located.

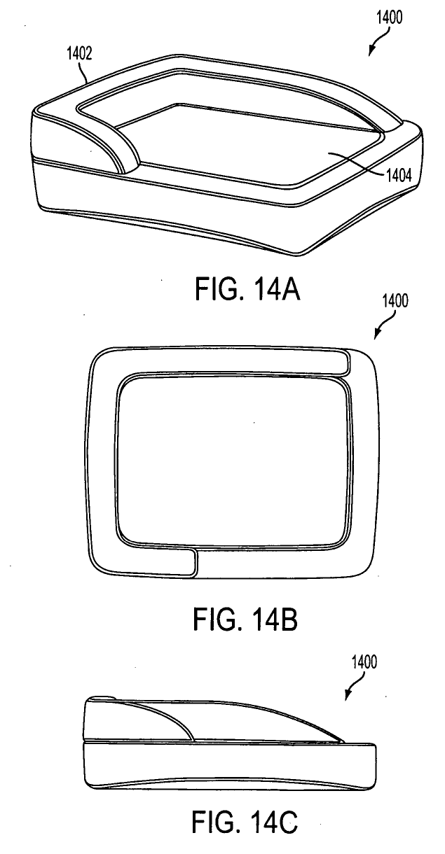

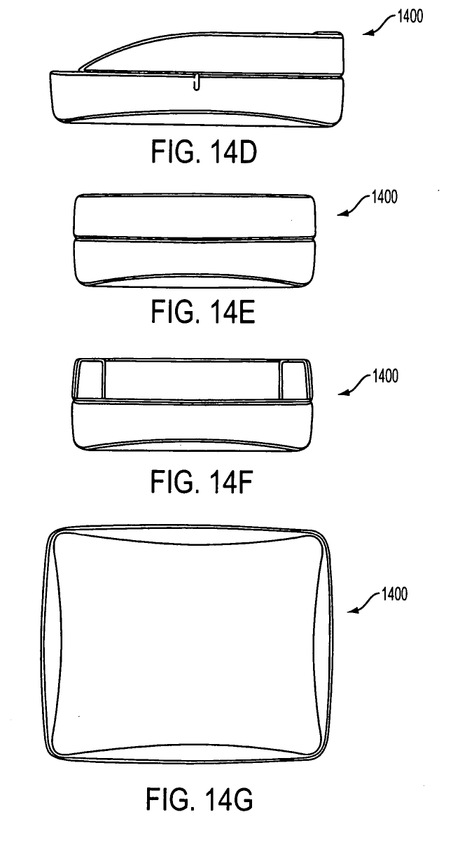

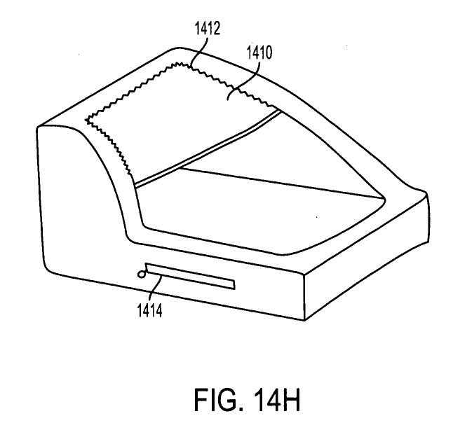

FIGS. 14A-14G provides various different views of a pet bed 1400 according to at least one embodiment of the present invention. As shown in FIG. 14A, pet bed 1400 includes both a frame 1402 (which may function similarly to frame 200 shown in FIGS. 2A-2B and described above) and a heated pad 1404 (which may function similarly to pad 100 shown in FIGS. 1A-1C and described above). Although not shown, heated pad 1404 may include various aesthetic features (e.g., a pattern print on its top portion). Moreover, various different types of materials may be used to construct the top portion of pad 1404 (as explained above in connection with top portion 102 of pad 100, which is shown in FIGS. 1A-1C). Moreover, pad 1404 may be either permanently or, according to various other embodiments, fixably (non-permanently) attached to frame 1402.

In an alternative or further embodiment, the frame shown in FIG. 14H may additionally include a “roof” portion to create a closed-in “den” effect, which may be appreciated by canines. This roof portion also can be retractable or otherwise removable by a zipper 1412, Velcro fastener, or any other means.

The frame in FIG. 14H additionally includes at least one pocket 1414. The pocket can be used for storing pet treats or toys. In at least one embodiment, the pocket can be sealingly opened and closed, such as with a “Ziploc” type seal, so that the pet cannot discern pet treats stored therein. In at least another embodiment, the pocket can include openings so that the pet can smell a scent emitted from items stored therein. This can be particularly advantageous if a pet owner wishes to insert a plant material or other chemical to induce the pet to sleep or otherwise become sedated. In a further embodiment, one or more pockets can be included in the pet bad itself, rather than or in addition to the pet frame.

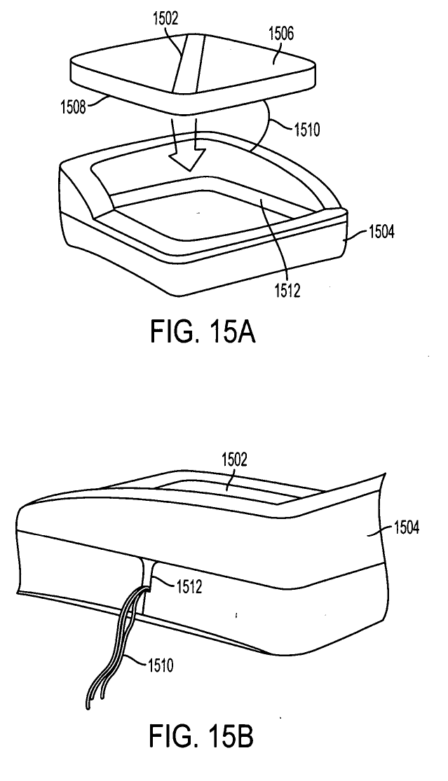

FIG. 15A provides a perspective view of a removable portable heated pad 1502 (which may be similar to pad 1404 shown in FIGS. 14A-14B) when removed from its frame 1504 (which may be similar to frame 1402 shown in FIGS. 14A-14G). According to various embodiments, top portion 1506 of pad 1502 is made of ballistic nylon or any other suitable (e.g., “cool”) type of material. Moreover, according to various embodiments, bottom portion 1508 of pad 1502 is made of imitation sheepskin or suede or any other suitable (e.g., “warm”) type of material that may be (but need not be) different from the material of top portion 1506. In this case, according to various embodiments, pad 1502 may be reversible (e.g., for warm and cold weather use) such that it can be retained in frame 1504 regardless of its orientation. Thus, because a single pad 1502 may be used to expose different surface materials to a pet, the owner of pad 1502 may be benefited, for example, by not having to buy and/or store multiple pads 1502, e.g., for use during different months of the year or for use by different pets.

Furthermore, according to various embodiments, any electronics (such as the electronics described above in connection with the heating function) being used may be fully enclosed in pad 1502, such that pad 1502 may be used as a standalone unit (e.g., when it is not desired to also use frame 1504). As shown in 15A, according to various embodiments, a power chord 1510 being used in connection with pad 1502 may run through an opening 1512 of frame 1504 when pad 1502 and frame 1504 are being used as a unit. FIG. 15B provides a different perspective view of the portable heated pad 1502 and frame 1504 shown in FIG. 15A when pad 1502 is not removed from frame 1504.

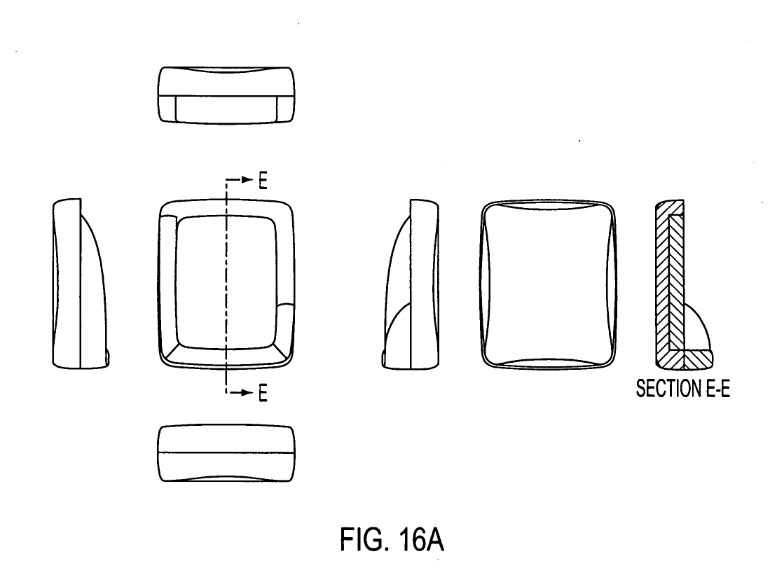

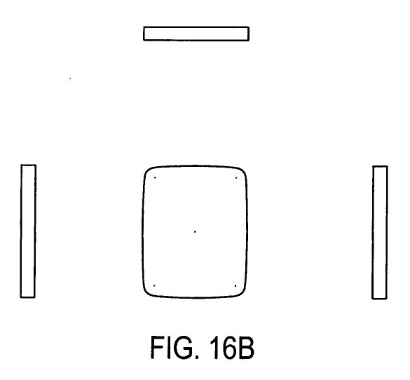

FIG. 16A is a schematic diagram indicating various dimensions of frame 1504 shown in FIGS. 14A-14G according to at least one embodiment of the present invention. It will be understood that the dimensions indicated in FIG. 16A are for illustrative purposes only. FIG. 16B is a schematic diagram indicating various dimensions of pad 1404 shown in FIGS. 14A-14B according to at least one embodiment of the present invention. It will be understood that, as with FIG. 16A, the dimensions indicated in FIG. 16B are for illustrative purposes only.

According to at least one embodiment of the present invention, the heated pet bed includes an integrated circuit microprocessor that receives signals from a user interface panel, sensors, or other input sources, and controls the application of power to the heater assembly for generating heat to the surface. In at least one embodiment, a user interface includes a switch or push button that enables a user to select different power levels, or heat settings, which in turn affect the pulse-width modulator (PWM) to apply comparatively more heat or less heat (referring to FIG. 8, this affects the duty cycle). As can be appreciated, a higher power level may be selected for a pet when the heated bed is being used in an environment that is very cold, whereas a lower power level may be selected when the environment is not perceived as being quite as cold. Since, in various embodiments, the heated seat is powered by a battery pack, the use of a comparatively lower power level results in less power being used, which conserves battery power. Thus, if it is desired to operate the heated pet bed with the battery pack for several hours, a lower power level may be selected so that the seat will continue to provide heat for a comparatively longer period of time. Although in various embodiments three power levels are provided, it can be appreciated that more or less power levels can be provided without detracting from features of the invention.

By incorporating capability for selecting between distinct power levels, a user also is able to adjust how quickly the heated pet bed reaches a desired temperature range to provide comfort for a pet. For example, a user may initially select the highest power setting to provide an initial heat ramp until the pet begins to feel comfortable. At that point, the user will then adjust the heat setting by selecting one of the two other high/low settings. Thus, by adjusting the power levels between higher and lower settings, a user is able to operate the heated seat so as to heat up more quickly than if only one or two power levels were provided.

In various embodiments according to the present invention, power levels can automatically be selected. In one embodiment, when the heater for the heated pet bed is first turned on, the highest duty cycle is selected so as to warm the pet bed as quickly as possible. After a certain, programmed amount of time, a microcontroller switches to a lower duty cycle to maintain heat while conserving battery power. Alternatively, in another embodiment, the microcontroller switches to a lower duty cycle once upon receiving input from an integrated thermostat indicating that the pet bed surface has attained a predetermined, programmed temperature. As a further embodiment, the timer value or temperature value may be user-programmable.

In embodiments where pressure or vibration sensors are used, the heated pet bed may be “switched” on but remain in a power-save state until a pet is seated or is lying upon the pet bed. In such a case, the microcontroller may be programmed to begin applying heat at the highest duty cycle upon detecting that the pet bed is in use by a pet. If a timer is used, the timer in the microcontroller will begin once the microcontroller detects that the pet bed is in use.

In a further embodiment, the heated pet bed may be “switched” on but remain in a power-save state until an infrared detection sensor determines that a pet is in range of the pet bed. In accordance with the invention, the microcontroller can exit a power-saving mode upon detecting movement within a range of distance from the bed, and begin the applying heat to the heating element as described above. In this manner, the pet bed will begin to warm before the pet reaches the padding, and will be enticed to lay upon the padding. Since the infrared detector may have many false positives (e.g., as persons walk by the pet bed), the microcontroller can be configured to re-enter the powersave mode if a pressure sensor or vibration sensor does not detect that the pet bed is in use by a pet within a short amount of time. In an additional embodiment, upon detecting the presence of an animal, the pet bed may begin to warm at an extra high setting (e.g., with a high duty cycle if powered by PWM) to attract and train the animal to lay upon the padding, before the microcontroller switches to a lower heat power level to conserve power after a predetermined amount of time.

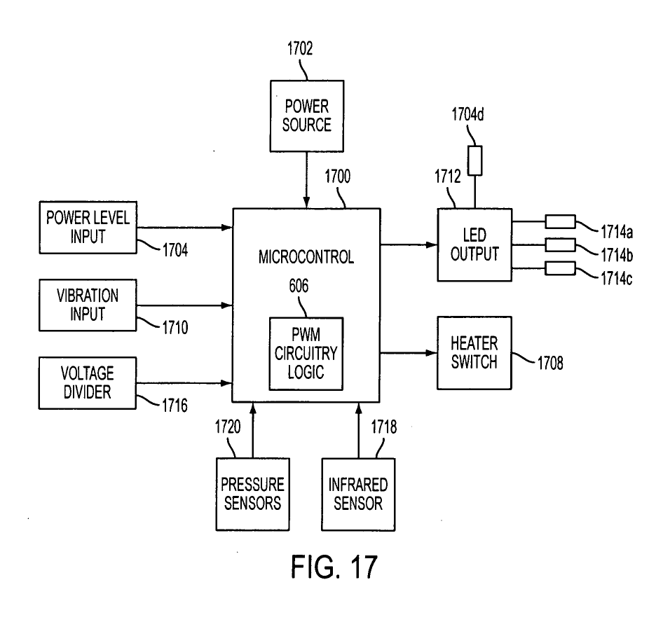

FIG. 17 illustrates an integrated circuit microcontroller assembly in accordance with at least one embodiment of the present invention. As can be seen, microcontroller 1700 receives DC power from power source 1702. The microcontroller 1700 can be, for example, an ELAN 78P458 programmable general purpose 8 bit microcontroller. The power source 1702 may be a rechargeable battery pack, as described above. Alternatively, or in addition, the microcontroller 1700 may accept power inputs from a car adapter or an AC source. The microcontroller may also receive a power level input 1704, which is an electrical signal input from a user interface. The user interface may include an on/off switch or button, and a button, switch, dial, or other adjuster for indicating a power level (although the these may be combined into a single button, switch, dial or knob). Based upon this input, the PWM circuitry logic 1706 programmed within microcontroller 1700 determines a PWM duty cycle, which is used to turn on and off the heater switch 1708 for applying power or disconnecting power from the heater.

In at least one embodiment, the microcontroller sends one or more signals to a panel printed circuit board assembly to trigger a display on the user interface. The main power switch or button may be a lighted switch/button to provide visual confirmation to the user that the heated pet bed is operating. Likewise, the power level switch/button may be lighted to provide a visual indication to the user concerning the power level at which the apparatus is operating. Alternatively, the switches/buttons trigger one or more LEDs that are separate from the switches/buttons themselves, to provide a visual indication of the selected power level. For an indication of power levels, multiple LEDs may be provided. In the at least one embodiment having three power levels, three LEDs will be illuminated when the highest power setting is selected, two LEDs will be illuminated when the medium power setting is selected, and a single LED is illuminated for the lowest power setting. The microcontroller may receive a user's power level selection from the power level button as a signal from a circuit board associated with the user interface. Again, based on the user's power setting, a PWM circuit determines the appropriate duty cycle, and the microcontroller sends power to the heater in accordance with the selected duty cycle. The PWM circuitry can be in a separate microcontroller, such as that shown and described with reference to FIG. 7B, or in a general microcontroller that can also provide control of other features, such as lighting, powersave, and low battery cutoff, as will now be described.

Referring back to FIG. 17, microcontroller 1700 provides one or more electrical signals to LED output(s) 1712 to provide an indication to the user whether the heated seat is in operation. In one embodiment, when the microcontroller 1700 receives input from power level input 1704 indicating that the heated seat is powered on, at least a first LED 1714d is illuminated. Depending upon the power level that is selected at power level input 1704, one or more of the LEDs 1714a, 1714b, and 1714c are illuminated from LED output 1712. In a preferred embodiment, capability is provided for three power levels, and each of three LEDs receives a signal from a separate pin on microcontroller 1700.

Microcontroller 1700 may additionally receive an electrical signal from a vibration input 1710, one or more pressure sensors 1720, or an infrared sensor 1718. With regard to the vibration sensor, in at least one embodiment, an electrical signal is transmitted whenever the heated seat is powered on and a vibration is experienced, which temporarily moves a ball from atop the sensor. The microcontroller 1700 uses this electrical signal to reset a counter, which times out if no vibration is experienced within a predetermined amount of time. If the timeout circuit within microcontroller 1700 expires, it is determined that the heated seat is not in use, and it enters a powersave state, whereby the heater switch is turned off such that no power is supplied to the heater, and the LEDs 1714a-d are turned off to signal to the user that the heated seat is not providing heat.

Microcontroller 1700 may also receive input from voltage divider 1716. This is used to detect when the battery source has reached a critically low battery level. The voltage divider provides an analog voltage signal that is based upon the battery voltage level Vref. This level is then supplied to an analog to digital converter input pin in the microcontroller 1700, which then converts the signal into a digital value. If the digital value falls below a threshold value stored in microcontroller memory, the firmware executes a routine to turn off the heater supply 1708 and to send a blinking signal to LED output 1712 to indicate to the user that the battery must be re-charged. In at least one embodiment, when the firmware enters this state, all three LEDs begin blinking. This circuitry prevents overdischarging, which may prematurely cause the battery to become permanently discharged.

Although the invention has been described and illustrated in the foregoing illustrative embodiments, it is understood that the present disclosure has been made only by way of example, and that numerous changes in the details of implementation of the invention can be made without departing from the spirit and scope of the invention. For example, it will be understood that features in one embodiment may be combined with features in other preferred embodiments. As an example, a fuse circuit similar to fuse circuit 906 shown in FIG. 9 may be included in circuit 700 of FIG. 7A without departing from the principles of the present invention.

Moreover, it will be understood that, although the invention is described with particular attention to portable heated pads for use with pets, the invention is not limited in this manner. For example, heated pads may also be used with young children or infants, e.g., in a crib. Moreover, the concepts described herein can be extended, for example, to couches or bedding, whether portable or otherwise.

Other embodiments, extensions, and modifications of the ideas presented above are comprehended and should be within the reach of one versed in the art upon reviewing the present disclosure. For example, timer circuitry may also be used in connection with some or all of the embodiments described above. In this case, the timer circuitry may, for example, automatically deactivate (e.g., open) the heating circuit (regardless of the other conditions) during certain times of the day. According to various other embodiments, timer circuitry may also be used to automatically activate the heating circuit, regardless of the other conditions (e.g., to attract a pet by the resulting heat). Accordingly, the scope of the present invention in its various aspects should not be limited by the examples presented above. The individual aspects of the present invention, and the entirety of the invention should be regarded so as to allow for such design modifications and future developments within the scope of the present disclosure.

What is claimed is:

1. A portable heated bedding apparatus for pets, comprising:
cushion material sized for accommodating a pet animal;
a heating element to provide heat to an animal laying upon the cushion material; and
at least one battery for supplying electrical current to the heating element.

2. The portable heating bedding apparatus of claim 1, wherein the at least one battery is located inside the cushion material.

3. The portable heating bedding apparatus of claim 2, wherein the cushion material includes an opening for removable insertion of the at least one battery.

4. The portable heating bedding apparatus of claim 1, further comprising a power source selector, wherein the heating element is adapted to receive electrical current from either the at least one battery or an AC power source.

5. The portable heating bedding apparatus of claim 4, wherein the power source selector additionally switches the apparatus off.

6. The portable heating bedding apparatus of claim 1, further comprising a power source selector, wherein the heating element is adapted to receive electrical current from either the at least one battery or a DC automobile power source.

7. The portable heating bedding apparatus of claim 1, further comprising a frame for receiving the cushion material.

8. The portable heating bedding apparatus of claim 1, wherein the cushion material is orthopedic foam.

9. The portable heating bedding apparatus of claim 1, further comprising an indicator when the apparatus is powered on.

10. A portable heated bed, comprising:
cushion material for providing bedding support; and
a heating element comprising silver carbon paste silk screened upon a flexible substrate, the heating element positioned at or substantially near an outer surface of the cushion material for generating heat when electrical current is applied.

11. The portable heated bed of claim 10, further comprising a direct current power source.

12. The portable heated bed of claim 11, wherein the direct current power source is located within the cushion material.

13. The portable heated bed of claim 11, wherein the direct current power source is a rechargeable battery.

14. The portable heated bed of claim 13, further comprising a power source selector, wherein the heating element is adapted to receive electrical current from either the rechargeable battery or an AC power source.

15. The portable heated bed of claim 13, further comprising a power source selector, wherein the heating element is adapted to receive electrical current from either the rechargeable battery or a DC automobile power source.

16. A portable heated bed, comprising:
cushion material for providing bedding support; and
a heating element comprising flexible graphite fabric, the heating element positioned at or substantially near an outer surface of the cushion material for generating heat when electrical current is applied.

17. The portable heated bed of claim 10, further comprising a direct current power source.

18. The portable heated bed of claim 11, wherein the direct current power source is located within the cushion material.

19. The portable heated bed of claim 11, wherein the direct current power source is a rechargeable battery.

20. The portable heated bed of claim 13, further comprising a power source selector, wherein the heating element is adapted to receive electrical current from either the rechargeable battery or an AC power source.

21. The portable heated bed of claim 13, further comprising a power source selector, wherein the heating element is adapted to receive electrical current from either the rechargeable battery or a DC automobile power source.

22. A heated bedding apparatus, comprising:
a heating element for generating heat from electrical current; and
a temperature controller operatively connected to the heating element to control activation of the heating element with pulse width modulation.

23. The portable heated bedding apparatus of claim 22, further comprising a direct current power source.

24. The portable heated bedding apparatus of claim 23, wherein the direct current power source is a rechargeable battery.

25. The portable heated bedding apparatus of claim 24, further comprising a power source selector, wherein the heating element is adapted to receive electrical current from either the rechargeable battery or an AC power source.

26. The portable heated bedding apparatus of claim 24, further comprising a power source selector, wherein the heating element is adapted to receive electrical current from either the rechargeable battery or a DC automobile power source.

27. The portable heated bedding apparatus of claim 22, further comprising at least one pressure sensor, wherein the temperature controller disconnects current from the heating element when pressure is not detected.

28. The portable heated bedding apparatus of claim 23, wherein the temperature controller disconnects current from the heating element upon determining that the voltage supplied from the power source is below a critical threshold.

29. A bedding apparatus, comprising:
a heating element for generating heat from electrical current;
a temperature controller operatively connected to the heating element to control activation of the heating element; and
a sensor operatively connected to the temperature controller,
wherein the temperature controller activates the heating element upon detection by the sensor that the bedding apparatus is in use.

30. The portable heated bedding apparatus of claim 29, wherein the sensor is a vibration sensor.

31. The portable heated bedding apparatus of claim 29, wherein the sensor is a pressure sensor.

32. The portable heated bedding apparatus of claim 29, wherein the sensor is an infrared detector.

33. The portable heated bedding apparatus of claim 29, wherein the temperature controller provides a higher power setting upon detecting that the bedding is in use to train a pet to use the bed, and provides a lower power setting after a predetermined amount of time after detecting that the bedding is in use.

34. Portable heated bedding for a pet, comprising:
a cushion further comprising a heating element; and
a frame for containing the cushion,
wherein the cushion is removable from the frame.

35. The portable heated bedding for a pet of claim 34, wherein the cushion further comprises at least one pocket.

36. The portable heated bedding for a pet of claim 34, wherein the frame further comprises at least one pocket.

37. The portable heated bedding for a pet of claim 35, wherein the pocket is adapted for sealingly storing a pet treat.

38. The portable heated bedding for a pet of claim 35, wherein the pocket is adapted for containing a chemical substance to sedate an animal lying on the cushion, and for emitting a scent to affect the animal.

39. The portable heated bedding for a pet of claim 34, wherein the cushion is washable.
